(19) United States
(12) Patent Application Publication
(10) Pub. No.: US 2025/0100137 A1
(43) Pub. Date: Mar. 27, 2025

(54) CONTROL DEVICE

(71) Applicant: FANUC CORPORATION, Yamanashi (JP)

(72) Inventors: Takahiro KITANO, Yamanashi (JP); Masao MOTOHASHI, Yamanashi (JP)

(21) Appl. No.: 18/832,511

(22) PCT Filed: Feb. 8, 2022
(86) PCT No.: PCT/JP2022/004957

§ 371 Date: Jul. 24, 2024

(51) Int. Cl. B25J 9/16; B25J 15/02; B25J 19/06

(52) U.S. Cl. CPC B25J 9/1653; B25J 9/1674; B25J 15/02; B25J 19/06

(57) ABSTRACT

An object is to set a detection parameter used for detecting contact with a workpiece or pinching of the workpiece to an appropriate value without user's time and effort. A control device 40, 50 according to one aspect of the present disclosure is a control device that controls a servo motor 35 for driving a tool 30 for holding a workpiece W1 or applying a treatment to the workpiece W1. The control device includes a control unit 41 that selectively controls the servo motor in a preliminary adjustment mode in which the tool is operated in the absence of the workpiece and in an operation mode in which the tool is operated in the presence of the workpiece, and a parameter adjustment unit 42 that adjusts a detection parameter in the preliminary adjustment mode. The control unit controls the servo motor in the operation mode using the detection parameter adjusted by the parameter adjustment unit.

### RELATED APPLICATIONS

The present application is a National Phase of International Application No. PCT/JP2022/004957 filed Feb. 8, 2022.

### TECHNICAL FIELD

This disclosure relates generally to a control device.

### BACKGROUND ART

There is a technique of monitoring/limiting the current value of a servo motor included in a device such as a robot, a robot hand, or a spot welding gun so as to detect contact of the device with a workpiece or pinching of a workpiece by the device (for example, Patent Literature 1). This method has significant cost advantages because it does not require an external sensor or a floating mechanism. On the other hand, in this method, it is necessary to determine in advance a threshold value for detecting contact with a workpiece or pinching of a workpiece.

Conventionally, threshold values have been set manually by the user. However, the optimum threshold value varies depending on the type of the servo motor or the device. If the threshold value is set to a value larger than the optimum value, the load on the workpiece and the device increases, which may cause a failure. If the threshold value is set to a value smaller than the optimum value, the number of erroneous detections increases. Therefore, the work of setting the threshold value needs to be done carefully and accurately, which is a very time-consuming work.

### CITATION LIST

### Patent Literature

Patent Literature 1: Japanese Patent No. 4233584

### BRIEF DESCRIPTION OF THE DRAWINGS

FIG. 1 is a configuration diagram of a welding system including a control device according to a first embodiment.

FIG. 2 is a functional block diagram of the control device according to the first embodiment.

FIG. 3 is a supplementary diagram for explaining a threshold value calculation process by a threshold value calculation unit in FIG. 2.

FIG. 4 is a flowchart showing an example of preliminary adjustment by the control device according to the first embodiment.

FIG. 5 is a flowchart showing an example of the procedure of a search operation part of a welding operation by the control device according to the first embodiment.

FIG. 6 is a diagram supplementary to the explanation of the search operation of FIG. 5.

FIG. 7 is a functional block diagram of a control device according to a second embodiment.

FIG. 8 is a supplementary diagram for explaining a pinching operation by the control device according to the second embodiment.

FIG. 9 is a supplementary diagram for explaining a pinching operation by the control device according to the second embodiment.

FIG. 10 is a functional block diagram of a control device according to a third embodiment.

FIG. 11 is a supplementary diagram for explaining a search operation by the control device according to the third embodiment.

FIG. 12 is a functional block diagram of a control device according to a fourth embodiment.

FIG. 13 is a flowchart showing an example of a gain calculation process by the control device according to the fourth embodiment.

### DETAILED DESCRIPTION OF THE INVENTION

A control device according to one aspect of the present disclosure is a control device that controls a servo motor for driving a tool for holding a workpiece or applying a treatment to the workpiece. The control device includes a control unit that selectively controls the servo motor in a preliminary adjustment mode in which the tool is operated in the absence of the workpiece and in an operation mode in which the tool is operated in the presence of the workpiece, and a parameter adjustment unit that adjusts a detection parameter in the preliminary adjustment mode. The control unit controls the servo motor in the operation mode using the detection parameter adjusted by the parameter adjustment unit.

Hereinafter, control devices according to the first, second, third, and fourth embodiments will be described with reference to the drawings. In the following description, constituent elements having substantially the same function and configuration are denoted by the same reference numeral, and repetitive descriptions will be given only where necessary.

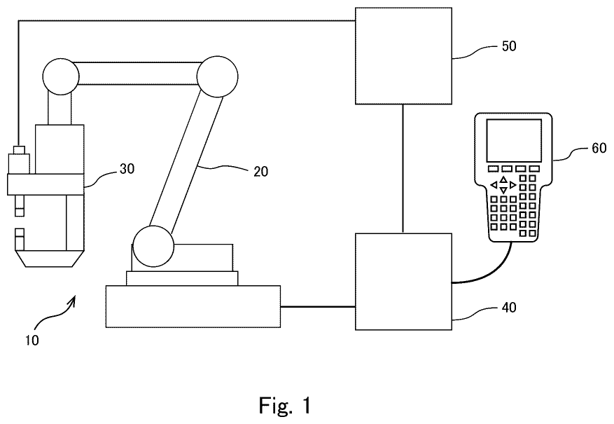

The control device according to the first embodiment will be described below with reference to FIG. 1 to FIG. 6. In the first embodiment, an example in which a spot welding gun for welding a workpiece is used as an example of a tool for applying a treatment to a workpiece, a robot arm mechanism is used as an example of a moving mechanism for moving the tool for applying a treatment to the workpiece, and contact of the spot welding gun with the workpiece is detected will be described. The detection parameter is a parameter for detecting contact of a tool such as a spot welding gun or a robot hand with the workpiece, and specifically corresponds to the threshold value of the current value of a servo motor to be described later.

As shown in FIG. 1, a welding system including the control device according to the first embodiment includes a robot arm mechanism 20 having a plurality of joint parts, a spot welding gun 30 mounted on a wrist part of the robot arm mechanism 20, a robot control device 40 that controls the robot arm mechanism 20, a welding gun control device 50 that controls the spot welding gun 30, and a teaching operation panel 60 connected to the robot control device 40. The robot arm mechanism 20 and the spot welding gun 30 constitute a welding robot 10.

The teaching operation panel 60 functions as an input device for inputting a user instruction to the robot control device 40 and a display device for displaying an output result of the robot control device 40. The welding gun control device 50 and the robot control device 40 are communicatively connected to each other. The robot arm mechanism 20 includes a plurality of servo motors that drive a plurality of joint parts. The plurality of servo motors are driven by control signals from the robot control device 40, and the joint parts rotate so as to change the position and posture of the spot welding gun 30.

The control device according to the first embodiment is a concept including the robot control device 40 and the welding gun control device 50. In the first embodiment, the welding gun control device 50 and the robot control device 40 are separately provided as separate devices, but it is possible to configure a single control device to have the functions of both the welding gun control device 50 and the robot control device 40.

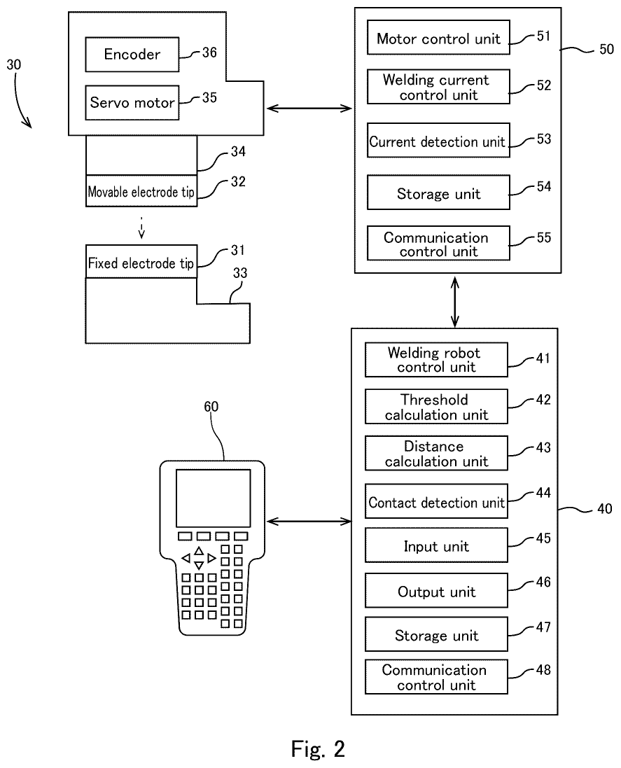

As shown in FIG. 2, the spot welding gun 30 includes a fixed electrode tip 31, a movable electrode tip 32 provided at a position facing the fixed electrode tip 31, a C-shaped fixed arm 33 that supports the fixed electrode tip 31, a movable arm 34 that supports the movable electrode tip 32 movably along the gun axis, a servo motor 35 that generates power for driving the movement of the movable arm 34, and an encoder 36 that detects the rotational position of the drive shaft of the servo motor 35. The fixed arm 33 and the movable arm 34 constitute an opening/closing mechanism. Data on the rotational position of the drive shaft of the servo motor 35 detected by the encoder 36 is sent to the welding gun control device 50.

The welding gun control device 50 includes a motor control unit 51, a welding current control unit 52, a current detection unit 53, a storage unit 54, and a communication control unit 55.

The motor control unit 51 controls the drive of the servo motor 35. Specifically, the motor control unit 51 supplies a current to the servo motor 35 based on an operation position command and a welding force command defined by a welding program and a preliminary adjustment program. The servo motor 35 is thereby driven to achieve the commanded position and welding force, and the movable electrode tip 32 is moved along the gun axis toward or away from the fixed electrode tip 31.

The welding current control unit 52 controls the welding current supplied to the fixed electrode tip 31 and the movable electrode tip 32. Specifically, the welding current control unit 52 supplies the electrode tips 31 and 32 with a welding current of a value corresponding to a welding current command defined by the welding program at a timing defined by the welding program.

The current detection unit 53 detects the current value of the current flowing in the servo motor 35. An existing method such as a current sensor can be used to detect the current value.

The storage unit 54 stores various types of information relating to the welding operation and the preliminary adjustment. The various types of information include information on the change with time of the current value of the servo motor 35 detected by the current detection unit 53.

The communication control unit 55 controls transmission and reception of various types of information to and from the robot control device 40. Through the processing of the communication control unit 55, the welding gun control device 50 sequentially transmits the information on the current value of the servo motor 35, and receives from the robot control device 40 control signals of the spot welding gun 30, such as the welding force command and the welding current command, based on the welding program and the preliminary adjustment program.

The robot control device 40 includes a processor configured by a CPU, a GPU, and the like, a RAM that functions as a main memory, a work area, and the like of the processor, and a storage device storing various programs, various types of setting information, and the like.

The storage device stores therein the welding program and the preliminary adjustment program. The welding program is a program executed in response to an operation mode being selected by the user, and is a program for causing the welding robot 10 to execute a predetermined welding operation. The preliminary adjustment program is a program executed in response to a preliminary adjustment mode being selected by the user, and is a program for obtaining a threshold value used for the welding operation in advance by calculation. When the preliminary adjustment program is executed, the change with time of the current value of the current flowing in the servo motor 35 of the spot welding gun 30 during a search operation in the absence of a workpiece is obtained, and the threshold value can be calculated. The search operation is an operation of moving the movable electrode tip 32 toward the fixed electrode tip 31. This operation is achieved by controlling the servo motor 35 which drives the movable arm 34. Typically, the search operation in the preliminary adjustment is performed in a predetermined specific posture. A threshold obtained by the search operation performed in the specific posture can be used for a search operation during welding in various postures. This is because the fluctuation range of the current value hardly depends on the posture of the spot welding gun 30, so that it is sufficient to adjust the threshold value for the workpiece detection only in the specific posture. Being able to cope with various postures by only the preliminary adjustment in the specific posture shortens the time for the preliminary adjustment and also contributes to shortening the cycle time. Needless to say, the preliminary adjustment may be performed for each posture in the operation mode, or a threshold value may be obtained for each of various postures.

The welding program describes an operation position command for the robot arm mechanism 20, an operation position command, a welding force command, and a welding current command for the spot welding gun 30, and the like. The preliminary adjustment program describes an operation position command for the robot arm mechanism 20, an operation position command for the spot welding gun 30, and the like.

The robot control device 40 functions as a welding robot control unit 41, a threshold value calculation unit 42, a distance calculation unit 43, a contact detection unit 44, an input unit 45, an output unit 46, a storage unit 47, and a communication control unit 48. The welding robot control unit 41 controls the welding robot 10. Specifically, the welding robot control unit 41 controls the welding gun control device 50 (the spot welding gun 30) in accordance with the preliminary adjustment program in order to cause the spot welding gun 30 to execute the search operation. Further, the welding robot control unit 41 controls the robot arm mechanism 20 and the welding gun control device 50 (spot welding gun 30) in accordance with the welding program in order to cause the welding robot 10 to execute the welding operation.

The threshold value calculation unit (corresponding to the parameter adjustment unit) 42 calculates the threshold value based on the change with time of the current value of the servo motor 35 during the search operation in the preliminary adjustment. A method of calculating the threshold value by the threshold value calculation unit 42 will be described later. The current value of the servo motor 35 during the search operation of the spot welding gun 30 is detected by a current detection unit 53 of the welding gun control device 50.

The distance calculation unit 43 calculates the distance from the start of the search operation to the stabilization of the current value of the servo motor based on the change with time of the current value of the servo motor during the search operation in the preliminary adjustment. A method of calculating the distance by the distance calculation unit 43 will be described later.

The contact detection unit 44 detects contact of the spot welding gun 30 (movable electrode tip 32) with the workpiece by comparing the current value of the servo motor 35 detected by the current detection unit 53 of the welding gun control device 50 during the welding operation with the threshold value calculated in the preliminary adjustment.

The input unit 45 inputs a user operation through an input device, such as the teaching operation panel 60, to the robot control device 40. Through the processing of the input unit 45, for example, the preliminary adjustment mode or the operation mode is input to the robot control device 40 in accordance with a user instruction. The output unit 46 generates screen data for displaying information relating to the welding operation and the preliminary adjustment, such as the threshold value calculated by the threshold value calculation unit 42 and the distance calculated by the distance calculation unit 43, and outputs it to a display device such as the teaching operation panel 60.

The storage unit 47 stores various types of information relating to the welding operation and the preliminary adjustment. For example, the storage unit 47 stores information on the threshold value calculated by the threshold value calculation unit 42 in the preliminary adjustment and information on the distance calculated by the distance calculation unit 43 in the preliminary adjustment. A predetermined value for determining whether the threshold value calculated by the threshold value calculation unit 42 is too large is also stored in the storage unit 47.

The communication control unit 48 controls transmission and reception of various types of information to and from the welding gun control device 50. Through the processing of the communication control unit 48, the robot control device 40 transmits control signals such as a welding force command and a welding current command based on the welding program and the preliminary adjustment program to the welding gun control device 50, and sequentially receives information on the current value of the servo motor 35 from the welding gun control device 50.

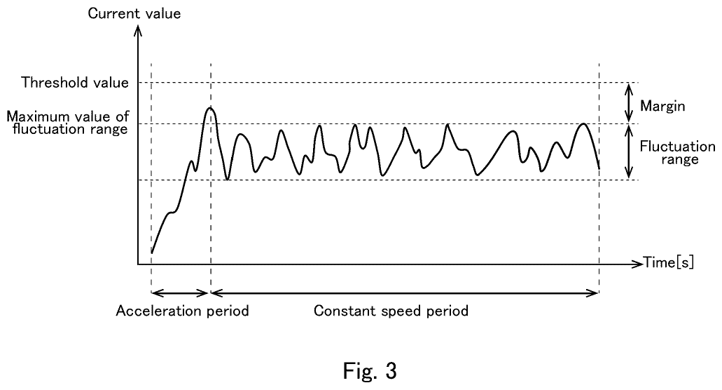

Hereinafter, a threshold value calculation process by the threshold value calculation unit 42 and a distance calculation process by the distance calculation unit 43 will be described with reference to FIG. 3. FIG. 3 shows an example of the change with time of the current value of the servo motor 35 during the search operation in the preliminary adjustment.

As shown in FIG. 3, immediately after the search operation is started, the movable arm 34 is being accelerated; therefore, the current value of the servo motor 35 for driving the movable arm 34 gradually increases. The current value of the servo motor 35 is not stable in the section where the movable arm 34 is accelerating. In the section where the current value is not stable, the detection accuracy of contact with the workpiece is reduced, so that the start position of the search operation or the like is adjusted to prevent the movable electrode tip 32 from coming into contact with the workpiece in the section where the current value of the servo motor 35 is not stable.

When a predetermined period of time has elapsed since the start of the search operation, the movable arm 34 is moved at a constant speed, so that the current value of the servo motor 35 fluctuates within a predetermined fluctuation range and stabilizes. The fluctuation of the current value of the servo motor 35 is caused by friction of a reduction gear that reduces the rotational speed of the servo motor 35 or the like. When the movable arm 34 driven by the servo motor 35 and the movable electrode tip 32 attached to the movable arm 34 come into contact with the workpiece, it becomes a load, so that the current flowing in the servo motor 35 increases. Therefore, a formula is made so as to make the threshold value greater than the maximum value of the current value of the servo motor 35 during the constant speed period in which the fluctuation of the current value of the servo motor 35 falls within the predetermined fluctuation range (referred to as a maximum fluctuation range value). Typically, the threshold value calculation unit 42 calculates a value obtained by adding a predetermined margin to the maximum fluctuation range value as the threshold value. Typically, the threshold value is an absolute value. However, the threshold value is not limited to absolute values. For example, since the current value of the servo motor 35 can be monitored even during operation, the threshold value may be a value relative to the maximum fluctuation range, a value multiplied by a predetermined coefficient that exceeds 1.0 as a percentage.

The distance calculation unit 43 calculates the distance from the start of the search operation to the stabilization of the current value of the servo motor 35. For example, the time from the start of the search operation to the stabilization of the current value can be identified by the change with time of the current value of the servo motor 35. The distance calculation unit 43 calculates the distance from the start of the search operation to the stabilization of the current value of the servo motor 35 based on the encoder position when the search operation is started and the encoder position after the lapse of time from the start of the search operation to the stabilization of the current value. For example, the point in time at which the current value of the servo motor 35 is stabilized can be after a predetermined time has elapsed since the current value begins to fall within a predetermined fluctuation range.

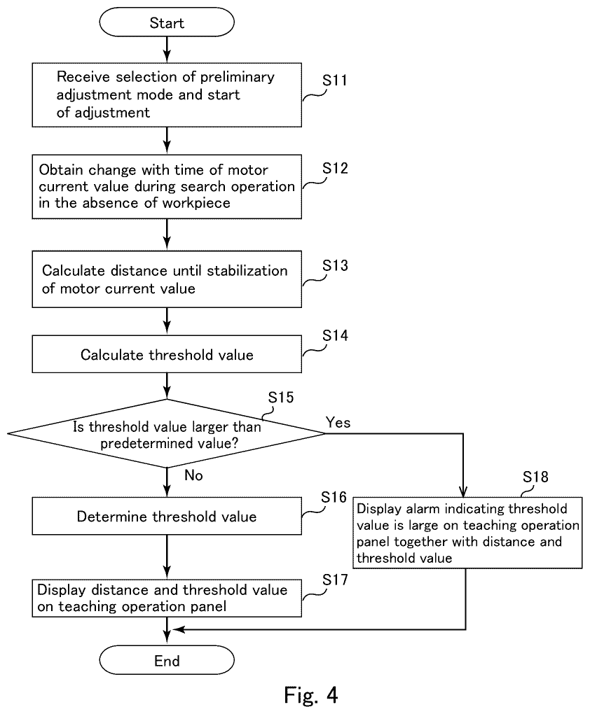

Hereinafter, with reference to FIG. 4, the control relating to the search operation in the preliminary adjustment by the control device according to the first embodiment will be described. Upon receiving a user's selection of the preliminary adjustment mode, the control device starts controlling the spot welding gun 30 in accordance with the preliminary adjustment program, and starts the search operation by the spot welding gun 30 (S11). The change with time of the current value of the servo motor 35 during the search operation is detected by the current detection unit 53 (S12). The threshold value and the distance are calculated based on the change with time of the current value of the servo motor 35 during the search operation (S13 and S14). When the threshold value is smaller than a predetermined value (S15; NO), the threshold value is determined (S16). Then, the threshold value and the distance calculated in steps S13 and S14 are displayed on the teaching operation panel 60 (S17). On the other hand, when the threshold value is larger than the predetermined value (S15; YES), an alarm for notifying the user that the threshold value is too large is displayed on the teaching operation panel 60 together with the threshold value and the distance calculated in steps S13 and S14 (S18).

It is desirable to perform the preliminary adjustment immediately before starting the actual welding operation. This allows the threshold value in a state close to the welding operation to be obtained, thereby improving the detection accuracy of contact with the workpiece in the welding operation. Here, the preliminary adjustment is performed in accordance with a user instruction, but the preliminary adjustment may be included as the first operation in the series of operations of the welding operation, and the preliminary adjustment may be automatically executed before the welding operation is started.

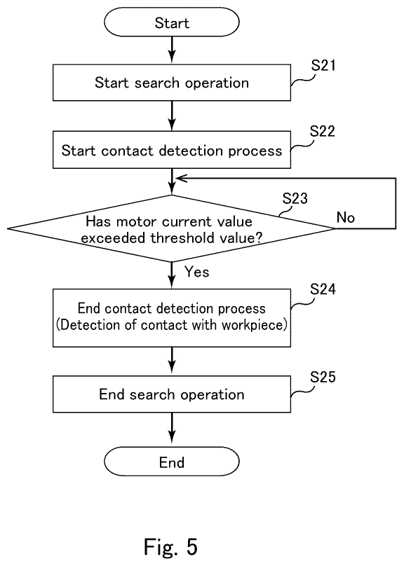

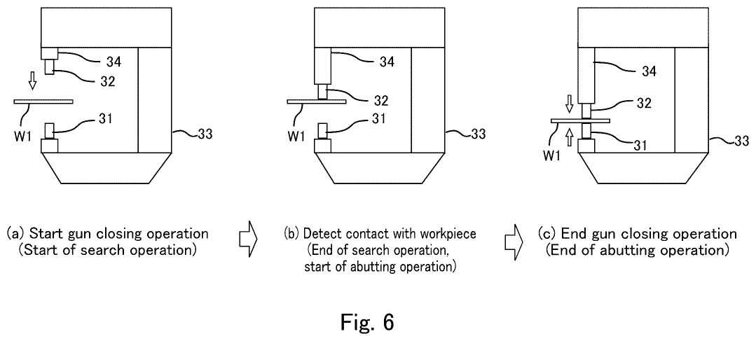

The control relating to the welding operation by the control device according to the first embodiment will be described below with reference to FIG. 5 and FIG. 6. FIG. 5 shows a procedure of the search operation by the spot welding gun 30 in the series of welding operations by the welding robot 10.

Upon receiving a user's selection of the operation mode, the control device starts controlling the welding robot 10 in accordance with the welding program and starts the welding operation by the welding robot 10. The robot arm mechanism 20 moves the spot welding gun 30 from a standby position to a hitting position, controls the servo motor 35 in order to start the search operation by the spot welding gun 30 (S21), and starts the process of detecting contact with the workpiece (S22). By the process of step S21, the movable electrode tip 32 is moved toward a workpiece W1 as shown in FIG. 6 (a).

The control device waits until the current value of the servo motor 35 exceeds the threshold value (S23; NO), and when the current value of the servo motor 35 exceeds the threshold value (S23; YES), the control device considers that the movable electrode tip 32 has come into contact with the workpiece W1 as shown in FIG. 6 (b), ends the process of detecting contact with the workpiece (S24), and ends the search operation by the spot welding gun 30 (S25).

The control device causes the welding robot 10 to start an abutting operation. As shown in FIG. 6 (c), in the abutting operation, the movable arm 34 is moved so as to move the movable electrode tip 32 toward the fixed electrode tip 31 at the same speed as the moving speed of the robot arm mechanism 20, while the spot welding gun 30 is moved upward by the robot arm mechanism 20. Accordingly, the workpiece W1 can be pinched between the movable electrode tip 32 and the fixed electrode tip 31 without moving the position of the workpiece W1. After the abutting operation is completed, a welding current is supplied to the movable electrode tip 32 and the fixed electrode tip 31, and the workpiece W1 pinched between the electrode tips 31 and 32 is welded. When the welding is completed, the spot welding gun 30 is returned to the standby position, and the series of welding operations is completed.

One feature of the control device according to the first embodiment is that it has a preliminary adjustment mode in addition to an operation mode in which the welding robot 10 is caused to actually execute the welding operation. The preliminary adjustment mode is a mode in which the welding robot 10 is caused to execute the search operation also included in the welding operation in the absence of the workpiece. Based on the change with time of the current value of the servo motor 35 in the preliminary adjustment mode, the threshold value for detecting contact of the spot welding gun 30 with the workpiece, which is used in the search operation included in the welding operation, can be obtained by calculation. As described above, the calculation of the threshold value does not require involvement of the user and thus is not dependent on the user's experience or skill level, reducing the user's time and effort.

Since the preliminary adjustment is performed using the spot welding gun 30 which is actually used, the threshold value can be set to a more appropriate value, and tool changes such as a change of the spot welding gun 30 can be flexibly coped with. Since the optimum threshold value may change due to aging degradation or temperature change, the preliminary adjustment may be performed periodically. Setting the threshold value to an appropriate value improves the workpiece detection accuracy.

When the threshold value is larger than expected, the user can be notified of the fact as an alarm. When the threshold value is larger than expected, the reduction gear of the spot welding gun 30 or the servo motor 35 may be out of order, friction of the reduction gear of the spot welding gun 30 may be large even if there is no failure, or a problem may have occurred in the search operation due to an inappropriate speed, acceleration time, gain, or the like of the search operation. Since the user can grasp the problem of the spot welding gun 30 and the problem of the search operation, the user can deal with these problems before actually executing the welding operation, and as a result, the work efficiency can be improved. Further, the user can modify the starting position of the search operation of the welding program as necessary by confirming the moving distance of the movable electrode tip 32 from the start of the search operation displayed on the teaching operation panel 60 to the stabilization of the current value of the servo motor 35. This contributes to shortening the time for the search operation or stable detection of contact with the workpiece.

The method of calculating the threshold value by the threshold value calculation unit 42 is not limited to the present embodiment. For example, the threshold value calculation unit 42 may calculate a value obtained by adding a predetermined margin to the center value of the fluctuation range as the threshold value. Further, when contact of a pair of fingers of a robot hand with the workpiece is detected as in the third embodiment to be described later, the pair of fingers may be pushed or pulled in the moving direction by the workpiece. In such a case, the threshold value calculation unit 42 may calculate a value obtained by subtracting a predetermined margin from the minimum value of the fluctuation range as the threshold value.

The search operation by the spot welding gun 30 may be repeatedly executed in the preliminary adjustment mode to acquire a plurality of data files relating to the change with time of the servo motor 35 during the search operation, and the threshold value calculation unit 42 may calculate the threshold value based on the acquired plurality of data files. For example, the threshold value calculation unit 42 can set, based on the plurality of data files, a value obtained by adding a predetermined margin to the average value of the maximum values of the fluctuation ranges of respective search operations as the threshold value.

The control device according to the first embodiment merely causes the teaching operation panel 60 to display the distance calculated in the preliminary adjustment. However, the control device may have a program modification unit that modifies the welding program based on the distance calculated in the preliminary adjustment. The program modification unit modifies the starting position of the search operation in the welding operation defined by the welding program, based on the moving distance of the movable electrode tip 32 from the start of the search operation to the stabilization of the current value of the servo motor 35. For example, if the position of the movable electrode tip 32 at the start of the search is close to the fixed electrode tip 31 and the movable electrode tip 32 reaches a position where it contacts or immediately before contacts the workpiece to be welded before the current value of the servo motor 35 stabilizes in the welding program before modification, the program modification unit modifies the position of the movable electrode tip 32 at the start of the search to a position farther from the fixed electrode tip 31. Accordingly, the workpiece can be stably detected. On the other hand, if the position of the movable electrode tip 32 at the start of the search is far from the fixed electrode tip 31 and the movable electrode tip 32 needs to be moved a long distance to reach a position where it contacts or immediately before contacts the workpiece to be welded even after the current value of the servo motor 35 stabilizes in the welding program before modification, the program modification unit modifies the position of the movable electrode tip 32 at the start of the search to a position closer to the fixed electrode tip 31. Accordingly, the moving distance of the movable electrode tip 32 can be set to an appropriate distance that is not too long, and the situation in which the time required for the welding operation is unnecessarily long can be avoided.

### Second Embodiment

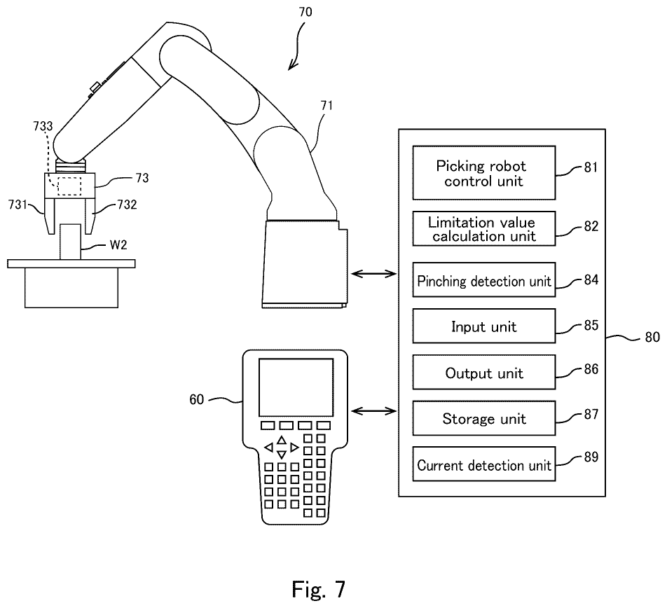

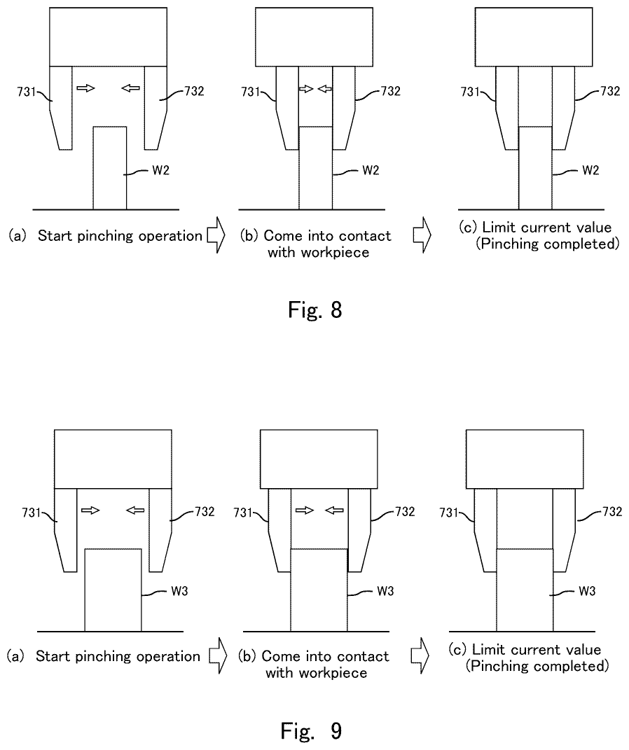

In the first embodiment, the threshold value is used to detect contact with the workpiece, but may be used to detect pinching (holding) of the workpiece. A control device according to a second embodiment will be described below with reference to FIG. 7, FIG. 8 and FIG. 9. In the second embodiment, an example in which a robot hand is used as an example of a tool for holding the workpiece, a robot arm mechanism is used as an example of a moving mechanism for moving the tool for holding the workpiece, and the workpiece is pinched by the robot hand will be described. The detection parameter is a parameter for detecting holding of the workpiece for example, and specifically corresponds to a limit value of the current value of the servo motor.

As shown in FIG. 7, a picking robot 70 includes a robot arm mechanism 71, and a robot hand 73 installed at the wrist part of the robot arm mechanism 71. The robot hand 73 includes a pair of fingers 731 and 732 provided to be openable and closable, and a servo motor 733 that drives the opening and closing of the pair of fingers 731 and 732. The control device 80 according to the second embodiment controls the picking robot 70.

The control device 80 includes a processor configured by a CPU, a GPU, and the like, a RAM that functions as a main memory, a work area, and the like of the processor, and a storage device storing various programs, various types of setting information, and the like. The storage device includes a picking program for causing the picking robot 70 to execute a predetermined picking operation when the operation mode is selected and a preliminary adjustment program for causing the picking robot 70 to execute a pinching operation when the preliminary adjustment mode is selected.

The control device 80 functions as a picking robot control unit 81, a limit value calculation unit 82, a pinching detection unit 84, an input unit 85, an output unit 86, a storage unit 87, and a current detection unit 89.

The picking robot control unit 81 controls the picking robot 70. Specifically, the picking robot control unit 81 controls the robot hand 73 in accordance with the preliminary adjustment program in order to cause the robot hand 73 to execute the pinching operation. Further, the picking robot control unit 81 controls the picking robot 70 in accordance with the picking program in order to cause the picking robot 70 to execute the picking operation.

The limit value calculation unit (corresponding to the parameter adjustment unit) 82 corresponds to the threshold value calculation unit 42 in the first embodiment. The limit value calculation unit 82 calculates the limit value based on the change with time of the current value of the servo motor 733 while the pinching operation by the robot hand 73 is being performed in the absence of the workpiece in the preliminary adjustment mode. The limit value here is used to limit the torque (force) for pinching the workpiece with the pair of fingers 731 and 732. Since a current larger than the limit value does not flow in the servo motor 733 for driving the pair of fingers 731 and 732, the workpiece is not pinched by the pair of fingers 731 and 732 with a force stronger than expected, and deformation of the workpiece such as crushing can be suppressed. Accordingly, the limit value is also a threshold value for detecting pinching of the workpiece by the pair of fingers 731 and 732 with a certain force. The process of calculating the limit value by the limit value calculation unit 82 is performed by the same method as the process of calculating the threshold value by the threshold value calculation unit 42 in the first embodiment, and therefore, the description thereof is omitted.

The pinching detection unit 84 monitors the current value of the current flowing in the servo motor 733 in the operation mode, and detects pinching of the workpiece by the robot hand 73 when the current value of the current flowing in the servo motor 733 in the operation mode reaches the limit value (threshold value) calculated in the preliminary adjustment. The picking robot control unit 81 limits the current value of the current output to the servo motor 733 so that a current larger than the limit value does not flow in the servo motor 733.

The input unit 85 inputs a user operation through an input device, such as the teaching operation panel 60, to the control device 80. The output unit 86 generates screen data for the teaching operation panel 60 to display information relating to the picking program and the preliminary adjustment program, such as the limit value calculated by the limit value calculation unit 82, and outputs the screen data to the teaching operation panel 60. The storage unit 87 stores various types of information relating to the picking operation and the preliminary adjustment. For example, the storage unit 87 stores information on the limit value calculated by the limit value calculation unit 82. The current detection unit 89 detects the current value of the current flowing in the servo motor 733.

The control relating to the picking operation by the control device 80 according to the second embodiment will be described below with reference to FIG. 8 and FIG. 9. Here, only the operation of pinching each of workpieces W2 and W3 by the robot hand 73 in the series of picking operations by the picking robot 70 will be described. FIG. 8 shows the pinching operation on a small workpiece W2, and FIG. 9 shows the pinching operation on a large workpiece W3.

When an input of the operation mode selected in accordance with a user instruction is received, the control on the picking robot 70 is started in accordance with the picking program so as to cause the picking robot 70 to start the picking operation. When the robot hand 73 is moved from the standby position to the picking position by the robot arm mechanism 71, the robot hand 73 is controlled in order to cause the robot hand 73 to execute the pinching operation on the workpiece W2, W3.

When the pinching operation on the workpiece W2, W3 is started, the pair of fingers 731 and 732 are moved toward each other as shown in FIG. 8 (a) and FIG. 9 (a). As shown in FIG. 8 (b) and FIG. 9 (b), even when the pair of fingers 731 and 732 are in contact with the workpiece W2, W3, if the current value of the current flowing in the servo motor 733 has not reached the limit value, the pair of fingers 731 and 732 are continuously moved toward each other. When the current value of the current flowing in the servo motor 733 reaches the limit value, the current value of the current output to the servo motor 733 is clamped at the limit value. The workpiece W2, W3 is pinched by the pair of fingers 731 and 732 with a predetermined torque, and the movement of the pair of fingers 731 and 732 is stopped as shown in FIG. 8 (c) and FIG. 9 (c). After the pinching operation is completed, the robot hand 73 is moved to the release position by the robot arm mechanism 71, a release operation by the robot hand 73 is performed at the release position, and the workpiece W2, W3 is released. Thereafter, the robot hand 73 is returned to the standby position by the robot arm mechanism 71, and the series of picking operations is completed. Since the picking system including the control device 80 and the picking robot 70 according to the second embodiment merely detects pinching of the workpiece by the pair of fingers 731 and 732 with a certain torque, it can handle picking operations of a plurality of types of workpieces W2 and W3 of different sizes as shown in FIG. 8 and FIG. 9 if they can be pinched with that torque. The control device according to the second embodiment has the same type of effect as the control device according to the first embodiment. That is, the user's time and effort for setting the limit value for pinching the workpiece can be reduced by the preliminary adjustment.

### Third Embodiment

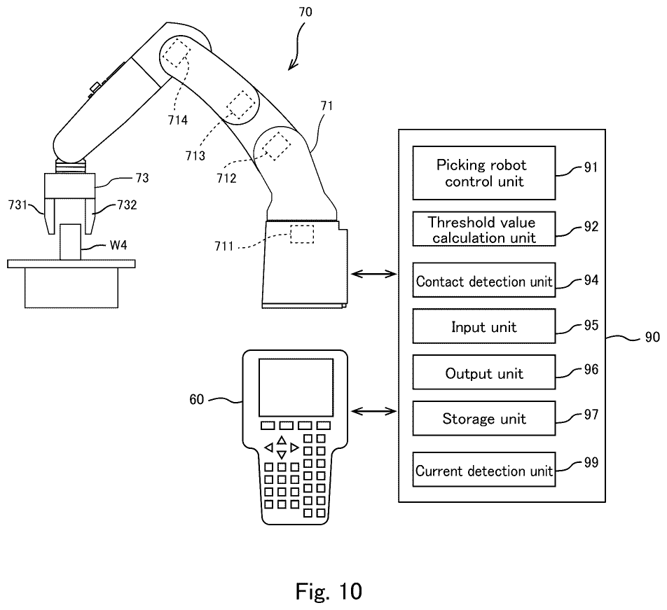

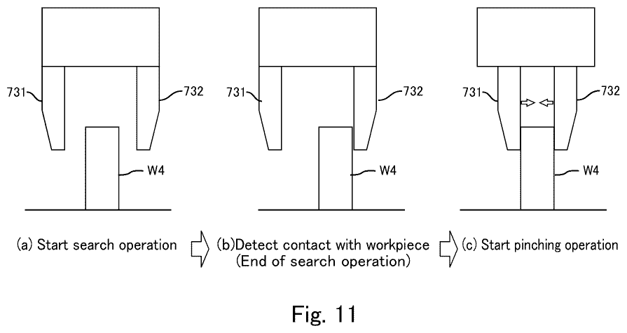

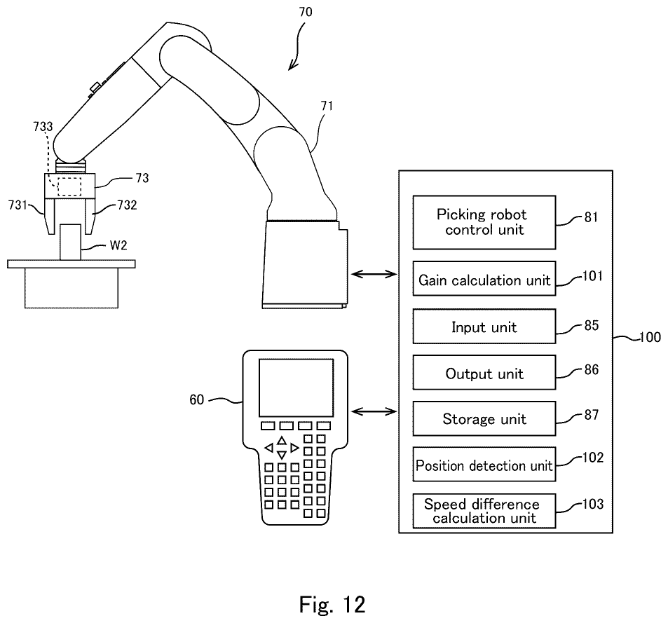

A control device according to a third embodiment will be described below with reference to FIG. 10 and FIG. 11. The third embodiment will be described by taking as an example the detection of a workpiece by a picking robot equipped with a robot hand. The third embodiment is different from the second embodiment in terms of the servo motor to be monitored and the detection operation. Specifically, in the second embodiment, the servo motor for driving the pair of fingers of the robot hand is monitored to detect pinching of the workpiece by the pair of fingers with a predetermined torque. On the other hand, in the third embodiment, the servo motor for driving each joint part of the robot arm mechanism equipped with the robot hand is monitored to detect contact of the workpiece with the pair of fingers. The only difference is the servo motor to be monitored. The functions of the control device according to the third embodiment have substantially the same configurations as those of the control device according to the second embodiment, so details regarding the common configurations are omitted.

The detection parameter is a parameter for detecting contact of the workpiece with the fingers, and specifically corresponds to the threshold value of the current value of the servo motor to be described later.

As shown in FIG. 10, a picking robot 70 includes a robot arm mechanism 71, and a robot hand 73 installed at the wrist part of the robot arm mechanism 71. The robot hand 73 includes a pair of fingers 731 and 732 provided to be openable and closable. The robot arm mechanism 71 includes a plurality of servo motors 711, 712, 713, and 714 corresponding to a plurality of joint parts, respectively.

The control device 90 includes a processor configured by a CPU, a GPU, and the like, a RAM that functions as a main memory, a work area, and the like of the processor, and a storage device storing various programs, various types of setting information, and the like. The storage device includes a picking program for causing the picking robot 70 to execute a predetermined picking operation when the operation mode is selected and a preliminary adjustment program for causing the picking robot 70 to execute a search operation when the preliminary adjustment mode is selected.

The control device 90 functions as a picking robot control unit 91, a threshold value calculation unit 92, a contact detection unit 94, an input unit 95, an output unit 96, a storage unit 97, and a current detection unit 99.

The picking robot control unit 91 controls the picking robot 70. Specifically, the picking robot control unit 91 controls the robot hand 73 in accordance with the preliminary adjustment program in order to cause the robot hand 73 to execute the search operation. Further, the picking robot control unit 91 controls the picking robot 70 in accordance with the picking program in order to cause the picking robot 70 to execute the picking operation.

The threshold value calculation unit (corresponding to the parameter adjustment unit) 92 corresponds to the threshold value calculation unit 42 in the first embodiment. The threshold value calculation unit 92 calculates the threshold value based on the change with time of the current value of the servo motor 711, 712, 713, 714 while the search operation by the robot hand 73 is being performed in the absence of the workpiece in the preliminary adjustment mode. The process of calculating the threshold value by the threshold value calculation unit 92 is performed by the same method as the process of calculating the threshold value by the threshold value calculation unit 42 in the first embodiment, and therefore, the description thereof is omitted.

The contact detection unit 94 detects contact of the robot hand 73 with the workpiece by comparing the current value detected by the current detection unit 99 in the operation mode with the threshold value calculated in the preliminary adjustment. The input unit 95 inputs a user operation through an input device, such as the teaching operation panel 60, to the control device 90. The output unit 96 generates screen data for the teaching operation panel 60 to display information relating to the picking program and the preliminary adjustment program, such as the threshold value calculated by the threshold value calculation unit 92, and outputs the screen data to the teaching operation panel 60. The storage unit 97 stores various types of information relating to the picking operation and the preliminary adjustment. For example, the storage unit 97 stores information on the threshold value calculated by the threshold value calculation unit 92. The current detection unit 99 detects the current value of the current flowing in the servo motor 711, 712, 713, 714.

The control relating to the picking operation by the control device 90 according to the third embodiment will be described below with reference to FIG. 11. Here, only the search operation part for the workpiece by the robot hand 73 in the series of picking operations by the picking robot 70 will be described.

When an input of the operation mode selected in accordance with a user instruction is received, the control on the picking robot 70 is started in accordance with the picking program so as to cause the picking robot 70 to start the picking operation. When the robot hand 73 is moved from the standby position to the picking position by the robot arm mechanism 71, the search operation of the robot hand 73 is started in order to cause the robot hand 73 to execute the search operation for a workpiece W4.

When the search operation for the workpiece W4 is started, the picking robot 70 is moved by the robot arm mechanism 71 with the robot hand 73 open, as shown in FIG. 11 (a). The current value of the servo motor 711, 712, 713, 714 during the operation of the robot arm mechanism 71 is monitored. When the current value of the servo motor 711, 712, 713, 714 exceeds the threshold value, contact of the workpiece W4 with the finger 732 is detected as shown in FIG. 11 (b), and the movement of the robot hand 73 is stopped. Thereafter, as shown in FIG. 11 (c), the robot hand 73 starts the operation of pinching the workpiece W4. After the pinching operation is completed, the robot hand 73 is moved to the release position by the robot arm mechanism 71, the release operation is performed by the robot hand 73 at the release position, and the workpiece W4 is released. Thereafter, the robot hand 73 is returned to the standby position by the robot arm mechanism 71, and the series of picking operations is completed. The control device according to the third embodiment has the same type of effect as the control device according to the first embodiment. That is, the user's time and effort for setting the threshold value for detecting contact with the workpiece to an appropriate value can be reduced by the preliminary adjustment.

### Fourth Embodiment

In the first embodiment, the second embodiment, and the third embodiment, the threshold value or the limit value of the current value is obtained as the detection parameter in the preliminary adjustment; however, a loop gain of feedback control may be adjusted as the detection parameter. When the position/speed feedback control is performed, flexible control can be performed so as to follow the external force by reducing the gain of the feedback loop. By reducing the gain, the tool can be stopped without applying an excessive load to the workpiece when the tool comes into contact with the workpiece. However, if the gain is too small, the tool or the robot equipped with the tool is stopped or the speed wobbles before the tool or the robot comes into contact with the workpiece due to the friction of the reduction gear or the like during the search operation. Therefore, the gain needs to be adjusted to an appropriate value. The detection parameter is a parameter for detecting holding of the workpiece for example, and specifically corresponds to the position/speed gain.

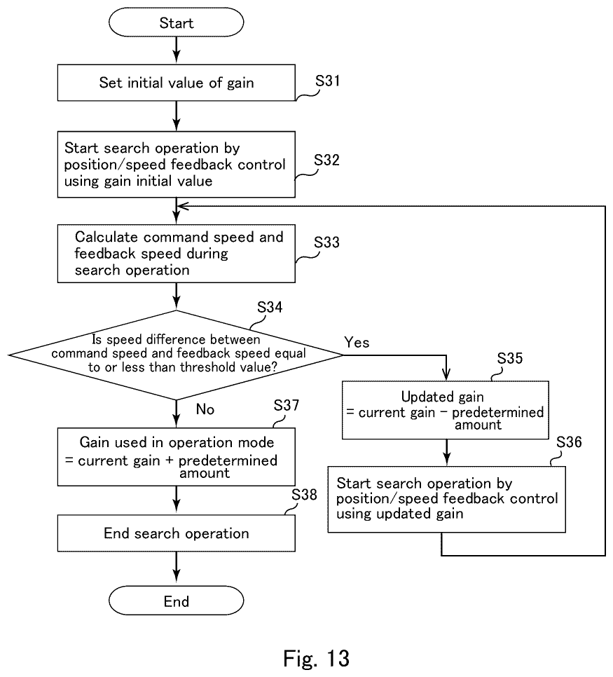

A control device according to a fourth embodiment will be described below with reference to FIG. 12 and FIG. 13. In the fourth embodiment, the detection of the workpiece W2 by the robot hand 73 will be described as an example. The control device 100 according to the fourth embodiment is configured by replacing the limit value calculation unit 82 in the control device 80 according to the second embodiment with a gain calculation unit 101, the current detection unit 89 with a position detection unit 102, and the pinching detection unit 84 with a speed difference calculation unit 103. In the fourth embodiment, the description of the contents described in the second embodiment is omitted.

The storage unit 87 stores the initial value of the gain and also stores the updated gain calculated by the gain calculation unit 101 through the preliminary adjustment. Further, a threshold value to be compared with the speed difference between the command speed and the feedback speed is stored. The storage unit 87 stores the preliminary adjustment program. This preliminary adjustment program describes an operation position command for the picking robot 70.

The gain calculation unit (corresponding to the parameter adjustment unit) 101 calculates the gain to be used in the operation mode through the preliminary adjustment. Specifically, when the speed difference calculated by the speed difference calculation unit 103 during the preliminary adjustment is equal to or less than the threshold value, the gain calculation unit 101 calculates the updated gain by subtracting a predetermined amount from the current gain. Details of the gain calculation process will be described later.

The position detection unit 102 detects the position of the pair of fingers 731 and 732 (the rotational position of the servo motor 733) based on the output of the encoder of the servo motor 733.

The speed difference calculation unit 103 calculates the speed difference between the command speed and the feedback speed. Specifically, the speed difference calculation unit 103 calculates the command speed based on the operation position command described in the preliminary adjustment program, and calculates the feedback speed based on the change with time of the position of the pair of fingers 731 and 732 detected by the position detection unit 102. The command speed is the ideal speed of the pair of fingers 731 and 732 when no load is being generated, and the feedback speed is the actual speed of the pair of fingers 731 and 732. That is, the speed difference calculation unit 103 calculates the speed difference between the ideal speed and the actual speed.

The gain calculation process by the control device 100 according to the fourth embodiment will be described below with reference to FIG. 13. As shown in FIG. 13, the control device sets the initial value of the gain to be adjusted upon receiving a user's selection of the preliminary adjustment mode (S31), starts control of the picking robot 70 in accordance with the preliminary adjustment program, and causes the picking robot 70 to start the search operation (S32). The search operation is performed by position/speed feedback control using the initial value of the gain. The position of the pair of fingers 731 and 732 is calculated by the position detection unit 102 based on the output of the encoder of the servo motor 733 during the search operation. Then, the speed difference calculation unit 103 calculates the command speed and the feedback speed, and calculates the speed difference between them (S33). When the speed difference is equal to or less than the threshold value (S34; Yes), the gain calculation unit 101 calculates the updated gain (S35), and the search operation by the position/speed feedback control using the updated gain is continued (S36). The processes of steps S33 to S36 are repeatedly executed until the speed difference becomes larger than the threshold value. When the speed difference is larger than the threshold value (S34; No), the gain used in the operation mode is calculated by the gain calculation unit 101 (S37) and stored in the storage unit 87, and the search operation is completed (S38).

The process of step S34 is equivalent to determining whether the search operation is being stably performed. When the speed difference between the command speed and the feedback speed is small, it means that the search operation is being stably performed. This means that there is room to lower the gain. On the other hand, when the speed difference between the command speed and the feedback speed is large, it means that the influence of the friction of the reduction gear or the like is large, the feedback speed is slow, and the search operation is not being stably performed. This means that the gain immediately before is the minimum gain at which the search operation can be performed. The gain calculation process shown in FIG. 13 provides a gain that allows a stable search operation to be performed while following the external force.

In the present embodiments, the current value of the servo motor and the rotational position of the servo motor are used to adjust the detection parameter in the preliminary adjustment and to detect the workpiece in the operation mode, but the estimated disturbance torque may be used instead of these. Here, the estimated disturbance torque is the difference between the torque actually output to the motor and the theoretically required motor torque, and the theoretically required torque can be calculated based on the physical model of the mechanism part.

In the present embodiments, the threshold value, the limit value, and the position/speed loop gain of the current value of the servo motor are obtained in the preliminary adjustment as detection parameters for detecting contact of a tool such as a spot welding gun or a robot hand with the workpiece or holding of the workpiece. However, the detection parameters obtained in the preliminary adjustment are not limited to these. For example, in the preliminary adjustment mode, the speed or acceleration time of the search operation may be adjusted as the detection parameter. In the present embodiments, the fluctuation of the current value is allowed, but the high-frequency components included in the fluctuation of the current value may be removed by a low-pass filter, and the threshold value, the limit value, and the position/speed loop gain may be calculated based on the change with time of the current value after the high-frequency components have been removed.

In the present embodiments, contact of the spot welding gun with the workpiece, pinching of the workpiece by the robot hand, and contact of the robot hand with the workpiece have been described as examples. One feature of all the embodiments is that the threshold value (limit value) for detecting contact with the workpiece and pinching of the workpiece in the actual operation is obtained in advance by calculation based on the change with time of the current value flowing in the servo motor when an operation similar to the actual operation is performed in the absence of the workpiece. Accordingly, the present embodiments can be applied to various devices that need to detect contact with the workpiece and pinching of the workpiece. For example, the present embodiments can be applied to a moving mechanism for moving a device having an opening/closing mechanism, such as a robot hand or a spot welding gun, to an arbitrary position and orientation. By comparing the current value of the servo motor for driving the moving mechanism with the threshold value, contact of the opening/closing mechanism provided in the moving mechanism with the workpiece can be detected. Further, by comparing the current value of the servo motor for driving the moving mechanism provided with a member to be brought into contact with the workpiece with the threshold value, contact of a member provided in the moving mechanism with the workpiece can be detected.

One feature of the control devices according to the present embodiments is that they have a preliminary adjustment mode. Having this mode allows the parameters used to control the tool during the actual operation to be adjusted in advance to appropriate values preliminary to the actual operation. Accordingly, the present embodiments can be widely applied to various operations and devices having parameters that can be adjusted in advance.

The tool that holds the workpiece is not limited to the robot hand, but may be an end effector that holds the workpiece using vacuum suction, an end effector that holds the workpiece using magnetic force, or the like. Further, the treatment to the workpiece is not limited to welding of the workpiece and contact with the workpiece. For example, the treatment to the workpiece may be riveting in which a rivet consisting of a head and a threadless body is driven, friction stir welding (FSW), clinching in which the workpieces are joined with a sheet metal interposed therebetween, seam welding in which the workpieces are joined by being sandwiched between cylindrical electrodes, or the like. The tool used to apply the treatment to the workpiece is not limited to the spot welding gun, but can be a variety of tools used for the above treatment. Further, the moving mechanism is not limited to the robot arm mechanism, and various moving mechanisms such as a slider mechanism driven by a servo motor can be used. According to the present embodiment, the parameters used for the control for operating these tools or moving mechanisms can be adjusted in advance in the preliminary adjustment mode.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A control device for controlling a servo motor for driving a tool for holding a workpiece or applying a treatment to the workpiece, comprising:
a control unit configured to selectively control the servo motor in a preliminary adjustment mode in which the tool is operated in the absence of the workpiece and in an operation mode in which the tool is operated in the presence of the workpiece; and
a parameter adjustment unit configured to adjust a detection parameter in the preliminary adjustment mode, wherein
the control unit controls the servo motor in the operation mode using the detection parameter adjusted by the parameter adjustment unit.

2. A control device for controlling a servo motor for driving a moving mechanism for moving a tool for holding a workpiece or applying a treatment to the workpiece, comprising:
a control unit configured to selectively control the servo motor in a preliminary adjustment mode in which the moving mechanism is operated in the absence of the workpiece and in an operation mode in which the moving mechanism is operated in the presence of the workpiece; and
a parameter adjustment unit configured to adjust a detection parameter in the preliminary adjustment mode, wherein
the control unit controls the servo motor in the operation mode using the detection parameter adjusted by the parameter adjustment unit.

3. The control device according to claim 1, further comprising:
a current detection unit configured to detect a current value of a current flowing in the servo motor, wherein
the parameter adjustment unit adjusts the detection parameter based on a change with time of the current value detected by the current detection unit.

4. The control device according to claim 3, further comprising a detection unit configured to detect contact of the tool with the workpiece or holding of the workpiece by the tool in the operation mode by comparing with the detection parameter or limiting the current value detected by the current detection unit.

5. The control device according to claim 1, further comprising:
a position detection unit configured to detect a rotational position of the servo motor, wherein
the parameter adjustment unit adjusts the detection parameter based on a change with time of the rotational position detected by the position detection unit.

6. The control device according to claim 1, further comprising a notification unit configured to notify a user of an alarm when the detection parameter is larger than a predetermined value.

7. The control device according to claim 1, further comprising:
a current detection unit configured to detect a current value of a current flowing in the servo motor;
a distance calculation unit configured to calculate in the preliminary adjustment mode a distance necessary for the current value to fall within a predetermined fluctuation range based on a change with time of the current value detected by the current detection unit; and
a display unit configured to display the distance.

8. The control device according to claim 1, further comprising:
a current detection unit configured to detect a current value of a current flowing in the servo motor;
a distance calculation unit configured to calculate in the preliminary adjustment mode a distance necessary for the current value to fall within a predetermined fluctuation range based on a change with time of the current value detected by the current detection unit; and
a program modification unit configured to modify an operation program used in the operation mode based on the distance.

9. The control device according to claim 1, wherein the tool is a spot welding gun.

10. The control device according to claim 1, wherein the tool is a robotic hand.

11. The control device according to claim 2, wherein the moving mechanism is a robot arm mechanism, and the servo motor drives a joint part of the robot arm mechanism.
